(19) United States
(12) Patent Application Publication
(10) Pub. No.: US 2026/0085549 A1
(43) Pub. Date: Mar. 26, 2026

(54) LATCH LOCKING SYSTEM

(71) Applicant: YONDR, INC., Los Angeles, CA (US)

(72) Inventors: Graham DUGONI, Los Angeles, CA (US); Anthony ABDELMALEK, Laguna Hills, CA (US); Steven BITONDO, White Plains, NY (US)

(21) Appl. No.: 18/897,268

(22) Filed: Sep. 26, 2024

(51) Int. Cl. E05B 9/08; E05B 27/00

(52) U.S. Cl. CPC E05B 63/121; E05B 27/0028; E05B 65/52; E05C 19/04

(57) ABSTRACT

Disclosed is a novel lock that includes a lock housing, lock cavity, a spring, a load plate, one or more pins, a post receiver and a post. The spring engages the lock cavity and load plate, securing the pins in place within a pin recess of the post receiver. The lock housing includes housing extensions to engage a case to lock the case in a closed configuration. The post receiver includes a pin guide with angled surfaces defining a travel path for the pins. The travel path, upon receiving input (e.g., a magnetic force and/or rotation) causes the pins to move up and out in response to force applied when a head region of the post pushes the pins apart.

### FIELD OF THE DISCLOSURE

Disclosed are mechanisms for locking an apparatus; and more particularly, disclosed is an apparatus and systems that provide a unique mechanical lock that securely limits and/or prevents the ability to access the contents contained therein.

### BACKGROUND OF THE DISCLOSURE

Handheld and mobile electronic devices have become commonplace in almost every environment. However, their presence and/or use may be unwelcome in certain settings. For example, in many instances, mobile electronic devices can be a distraction for their users and/or other surrounding users. For example, people who bring their mobile electronic devices, such as smart phones, to concerts, may be an unwelcome sight to performers, as well as other audience members. Similarly, in a school setting, smart phones may prevent students from engaging with the class and teachers, and can cause disruption to the education experience for all involved.

### SUMMARY OF THE DISCLOSURE

Locking an electronic device in a container (e.g., pouch, sleeve, bag, box and the like, and/or other type of apparatus for which a device can be secured within its confines) during an event has been presented as a solution; however, improved mechanisms for securing such containers in a locked state is required as conventional locking mechanisms and methods have fallen short in adequately maintaining the safe housing purported to be provided by such containers. For example, conventional locking methods for securing such devices may be susceptible to tampering due to access to internal components of the locking mechanism or the lock itself, allowing manipulation of latching components. Therefore, there is a need in the art for a lock for secure containers that can properly and effectively secure an electronic device stowed therein while providing increased resistance against tampering, while providing ease in unlocking when properly interacted with as per an unlock operation.

To that end, the disclosed system and apparatus provides a novel lock that can be utilized to secure an apparatus that houses a mobile electronic device. By way of non-limiting example, as one of skill in the art would recognize, according to some embodiments, the disclosed lock can be utilized in connection with the system and apparatus disclosed in commonly owned U.S. Pat. No. 9,819,788. For example, the pouch disclosed therein, and/or other types of pouches, containers and/or apparatus for which electronic devices may be securely stored/stowed therein may be configured with the disclosed lock provided herein, whereby a secure environment can be created via the inability to access the electronic device based on engagement of the lock.

Accordingly, as discussed herein, the absence of electronic devices in specific contexts confers multifaceted advantages across technical, societal, and personal spheres. From a technological perspective, the elimination of mobile phones mitigates electromagnetic interference in environments sensitive to such disturbances, such as medical facilities or scientific research laboratories. Additionally, it precludes potential security breaches in high-security zones and conserves critical resources like battery power and cellular data. In the social domain, the removal of these devices facilitates more authentic interpersonal engagement, elevating the caliber of discourse and enhancing group dynamics in professional and social settings. This absence engenders improved comprehension, empathy, and fortified interpersonal bonds. On an individual level, disengagement from mobile technology can alleviate stress and anxiety associated with perpetual connectivity, augment concentration and productivity, and cultivate mindfulness and present-moment awareness. Furthermore, it promotes superior sleep hygiene when devices are excluded from sleeping quarters and fosters the development of problem-solving acumen and self-sufficiency when instantaneous access to information is curtailed. Thus, periodic disconnection from mobile devices contributes to a more equilibrated and gratifying lifestyle, which may be in concert with a user's environment (e.g., at school, an event, a concert, and/or other venue where phones are not permitted).

Accordingly, in some embodiments, the instant disclosure provides a novel lock for a container that can be disengaged by an input (e.g., rotation, magnetic force, torque, and the like), as discussed herein. In some embodiments, the container, such as a pouch, sleeve, box and the like, may be used to render an electronic device inaccessible during a communal event such as a show, demonstration, display, or athletic competition within a concert hall, center, arena, or similar venue.

According to some embodiments, the disclosed lock described herein can include: a housing cavity that accommodates components such as a spring, load plate, two pins, and a receiver. The lock also can include a base that can couple with a post fastener, allowing for the post to be replaceable without removing the base. The lock assembly can include a spring that engages the lock cavity and a load plate, which secures the pins in place and protects the pins from tampering. Additional tamper-resistant features include angled surfaces on the lock housing and base. The receiver shape defines a travel path for the pins to ensure they move upward and outward when engaged by the post, and the load plate limits the travel of the pins, maintaining the lock's operability. In some embodiments, the lock can be disengaged using a rotational input and/or a magnet and/or electromagnet, which as provided below, can be effectuated via a separate key and/or station, for example. In some embodiments, the magnet is configured to release engagement of the pins against a neck region of the post which in turn enables rotation for disengagement of the lock.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates a front view of a lock in accordance with some embodiments of the present disclosure;

FIG. 2 shows a top view of the lock in accordance with some embodiments of the present disclosure;

FIG. 3 depicts a bottom view of the lock in accordance with some embodiments of the present disclosure;

FIG. 4 shows a side view of the lock in accordance with some embodiments of the present disclosure;

FIG. 5 illustrates an exploded view of the lock in accordance with some embodiments of the present disclosure;

FIG. 6 illustrates internal portions of the lock in accordance with some embodiments of the present disclosure;

FIG. 7 depicts a non-limiting example embodiment according to some embodiments of the present disclosure;

FIG. 8 depicts a non-limiting example embodiment according to some embodiments of the present disclosure; and

FIG. 9 depicts the lock securing the contents of a container in accordance with some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

For purposes of this disclosure, an electronic (or mobile, user, entity, subscriber or customer) device may include a computing device capable of sending or receiving signals, such as via a wired or a wireless network. A client device may, for example, include a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

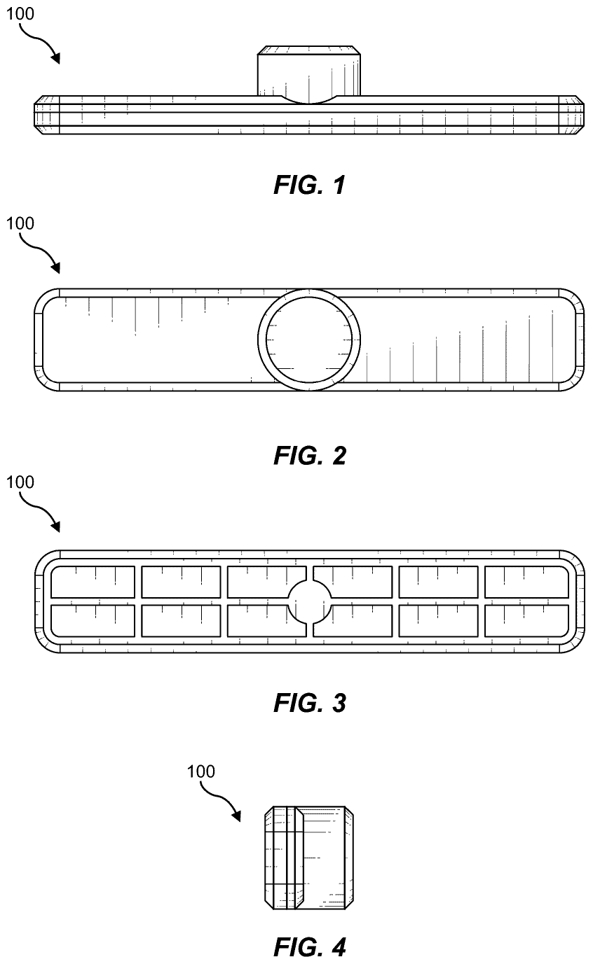

Certain embodiments and principles will be discussed in more detail with reference to the figures. According to some embodiments, FIGS. 1-4 depict lock 100. FIG. 1 depicts a front view of lock 100. FIG. 2 depicts a top view of lock 100. FIG. 3 depicts a bottom view of lock 100. And, FIG. 4 depicts a side view lock 100.

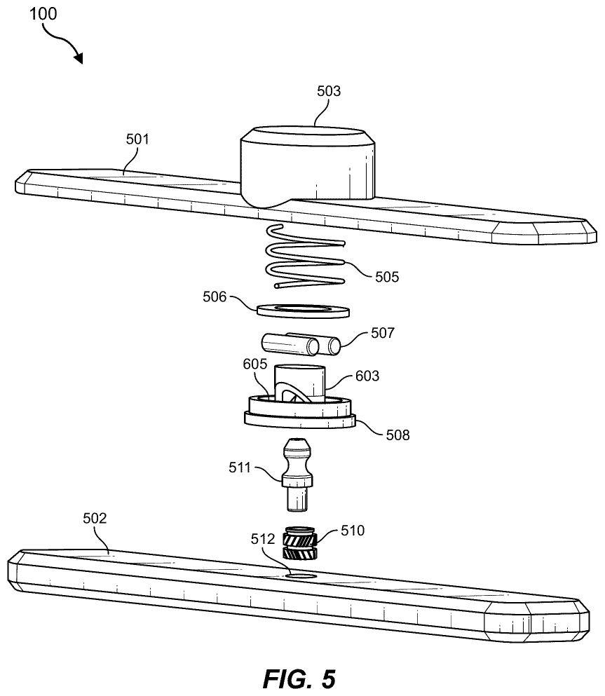

Referring now to FIG. 5, an exploded view of the lock 100 is provided. In some embodiments, the lock 100 includes top 503 (e.g., top feature associated with a top portion, as discussed herein), housing extension 501 (e.g. top portion), spring 505, washer 506, pins 507 (e.g., 2 pins), post receiver (or receiver) 508, post 511, post fastener 510, (e.g., M3 insert, for example) and base extension 502 (e.g., bottom portion).

According to some embodiments, while top 503 is depicted as a cylinder and housing extension 501 and a base extension 502 are depicted in a rectangular configuration, it should not be construed as limiting, as the shape of the top or extensions (or other components of the lock 100, as discussed infra) do not alter the operation of the lock 100, and can therefore be any type of known or to be known shape (e.g., oval, square, cube, and the like) without departing from the scope of the instant disclosure. For example, top 503 can be a cube or shape of a letter, for example, that sits atop a rectangular housing extension 501 component of lock 100.

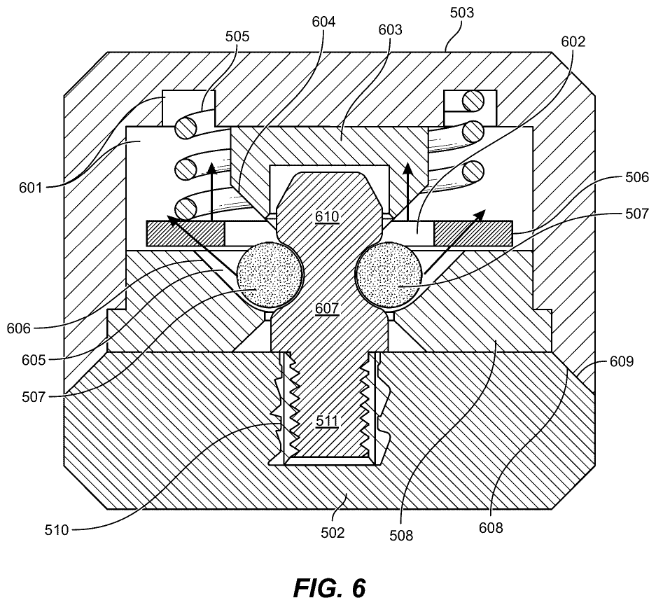

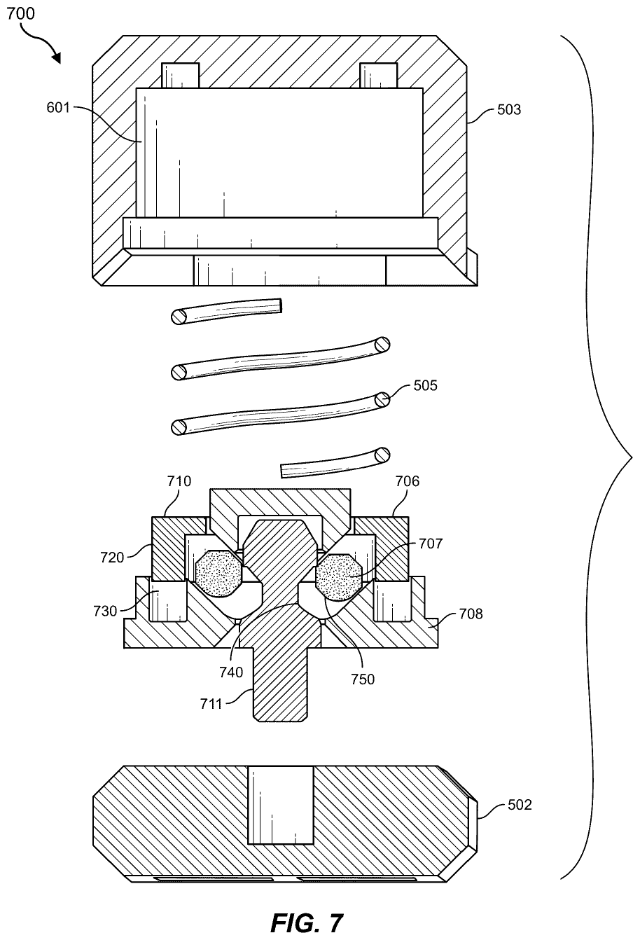

According to some embodiments, top 503 includes lock cavity 601, for which an example embodiment is depicted in FIG. 6. In some embodiments, lock cavity 601 is configured to house at least a portion of the components of lock 100, which can include one or more of a spring 505, washer 506, pins 507, and post receiver 508.

As provided herein, when the top 503 receives input (e.g., it is rotated in one direction that corresponds with an unlock instruction), such inner components can be caused to move or operate to unlock the lock 100 (e.g., release housing extension 501 from base extension 502 via post 511 releasing from receiver 508 and/or fastener 510). Conversely, when rotated in the other direction, such components can be caused to engage, thereby activating the lock such that it changes to a locked state and secures the extension components 501 and 502 together, thereby securing the lock (and/or the associated container, as discussed herein).

In some embodiments, top 503 can be configured as part of housing extension 501—that is, they form one component. In some embodiments, top 503 can be a separate component that attaches, affixes and/or fits within configurations of housing extension 501. Thus, as provided above, top 503 can be replaceable with other stylized tops, such that different brands, logos, colors, shapes, sizes, and the like, can be represented.

In some embodiments, top 503 can be configured with magnetic properties, which can be at its top surface (e.g., the portion of the detected cylinder that is visible in FIG. 2, for example). For example, such properties can be ferromagnetic, paramagnetic, diamagnetic, ferrimagnetic, and the like, and may be, but not limited to, coercive, permeable, susceptible and/or remanence. Thus, in some alternative embodiments, when top 503 is proximate to and/or in contact with a magnetic key (e.g., detacher), it can be caused to engage/disengage (e.g., rotate, as discussed herein, or pull/push, or otherwise cause the inner components to secure/press amongst themselves, as discussed herein).

In some embodiments, base extension 502 includes fastener cavity 512. Fastener cavity 512 within base extension 502 is configured in similar dimensions to post fastener 510, such that post fastener 510 fits within fastener cavity 512 within base extension 502. Accordingly, in some embodiments, fastener cavity 512 configured to engage a post fastener 510, such that the post fastener 510 is secured in place by friction force and/or melted material from the base extension 502, for example.

In some embodiments, the post 511 is removable (e.g., threaded) from the post fastener 510, which provides the benefit of being able to replace the post 511 with a post of a different length or other configurations (e.g., thread count and/or type, for example) without removing the fastener 510 from cavity 512 (or lock housing). Thus, for example, as provided above, when post 511 disengages from fastener 510, housing extension 501 and base extension 502 are free to separate, thereby unlocking the lock (and unlocking/opening its associated container, as provided herein).

In FIG. 6, according to some embodiments, depicted is an assembled view of the lock 100 (from FIG. 5). In some embodiments, spring 505, housed in top 503, as discussed supra, is configured to engage a top portion of the lock cavity 601 on one end, and washer 506 (e.g., or other type of load plate, such as, nut, magnet, steel plate, and the like) on the other. In some embodiments, the washer 506 includes a plate aperture 602 configured to enable pin guide 603 (of receiver 508) to pass therethrough, as depicted in FIG. 6. In some embodiments, pin guide 603 includes one or more angled surfaces 604 that extend from a center portion of the post receiver 508, which provides a suitable amount of space to receive the top portion 610 of post 511, as depicted in FIG. 6. In some embodiments, the pin recess 605 includes a substantially similar angled surface 606 (to surface 604), and can define a travel path for the pins 507, as discussed below in more detail.

According to some embodiments, in the locked position, as shown in FIG. 6, pins 507 are held in position at the neck region 607 of the post 511 by the downward force of the load plate 506. In some embodiments, the spring 505 is configured to apply at least a threshold satisfying amount of force onto the load plate 506 to prevent separation of the pins 507 from the neck region 607 when a user attempts to separate the top 503 from the base extension 502 using an amount of applied force and/or torque.

In some embodiments, lock 100 includes improved tamper resistant features. For example, as depicted in FIG. 6, in some embodiments, a bottom portion of the top 503 includes an angled surface 608 (e.g., angled relative a bottom of the post receiver 508), which is configured as an exterior wall of the cavity provided via top 503 (and/or housing extension 501, as discussed above respective to top 503 and extension 501 being one or separate components). Base extension 502, in some embodiments, includes a corresponding angled surface 609 configured to mate with the angled surface 608 of top 503/base extension 502. As one of skilled in the art would recognize, this improves integrity of the lock 100 by preventing an object, such as a lock pick for example, from being able to be inserted into an inner portion of top 503 and/or between housing extension 501 and base extension 502 (e.g., or within the lock cavity 601). In some embodiments, washer 506 offers additional security to the integrity of the lock 100; that is, for example, washer 506 is configured to cover the pin recess 605 portion of the post receiver 508 when in a locked position, further preventing access to pins 507.

In some embodiments, the travel path, as mentioned above, for post 511 can be defined by the opposing angles 604 and 606 of pin guide 603 (of receiver 508). In some embodiments, the travel path is configured to cause the pins 507 to be manipulated within and/or around receiver 508. For example, as depicted in FIG. 6, pins 507 can move diagonally from the center of receiver outwards as post 511 is inserted into the pin guide 603 and traverses to its resting position as engaged with each pin 507 on each side of post 511. Thus, for example, pins 500 can travel in both a horizontal and vertical directions (as per the arrows in FIG. 6) when head region 610 of the post 511 forces the pins 507 along the travel path (e.g., upon receiving rotational input via top 503, as discussed herein). In some embodiments, movement of pins 507 a threshold distance (e.g., that is proportional to the amount of rotational input, for example) for the post 511 to pass between each pin 507 may be accomplished when the washer 506 is withdrawn from the pin recess region 605 by an input force (e.g., rotational input to top 503, as discussed supra).

For example, when top 503 is turned in a direction associated with locking the lock 100, the rotational of top 503 causes the spring 505 to rotate in a manner that brings the other components in the cavity 601 together such that post 511 is secured within pins 507 and within receiver 508, as depicted in FIG. 6. Conversely, when rotated in the other direction, such components can be disengaged, causing, for example, pins 507 to enter the pin recesses thereby disengaging the post 511 from receiver, thereby disengaging extension components 501 and 502. Advantageously, in some embodiments, washer 506, when in an unlocked position, is configured to prevent the pins 507 from escaping the travel path into the lock cavity 601, which would render the lock inoperable.

In some embodiments, washer 506 may be made of a magnet and/or other type of known or to be known magnetic material, and/or have magnetic properties (similar to those of top 503, in some embodiments, as discussed supra) that can enable sufficient interaction with a detacher (e.g., a magnetic key, as referred to herein) to compress the spring 505 and release post 511, thereby disengaging lock 100.

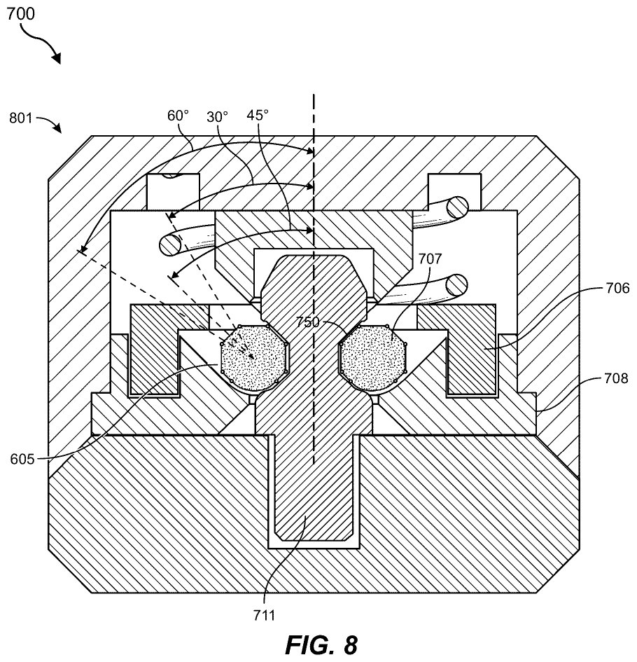

Referring now to FIG. 7, a non-limiting configuration for the lock 700 is depicted. All structures such as the top 503, spring 505, and base 502, as well as the functionality and movement of the pins 707 and angled load plate 706 is the same as pins 507 and load plate 706 as described above, and are not repeated in the interest of being concise. However, similar structures and functionality may be used from the description of FIGS. 1-6 to define the metes and bounds of the configuration shown in FIGS. 7 and 8, in accordance with some embodiments.

As shown in FIG. 7, the lock 700 includes an angled load plate 706, which includes a flat top portion 710, similar to load plate 506, but in addition includes a retention wall 720 configured to be inserted into a wall recess 730 formed in the outer portion of the post receiver 708. In some embodiments, at least a portion of the retention wall 720 is configured to remain within the wall recess 730 when the angled load plate 711 is fully compressed against spring 505, which may be the result of magnetic attraction as previously described in relation to FIGS. 5 and 6.

As illustrated in FIG. 7, the retention wall 711 is configured to prevent polygon pins 707 from escaping into the lock cavity 601, or being accessed from cavity 601, which is an improvement over the washer 506, as it allows for extra protection for polygon pins 707 in the event of tampering. In some embodiments, the polygon pins 707 each comprise a polygon shape with two or more discrete pin angles 750 formed into the polygon pin profile. In some embodiments, the discrete pin angles 750 are configured to engage corresponding discrete post angles 740 formed into post 711. The discrete pin angles 750 cause the polygon pins 707 to engage the post angles 740 of the post 711 with greater resistance than the round pin configuration shown in FIG. 6. Thus, a more force is required to pull the post 711 from the post receiver 708. In some embodiments all discrete pin angles 750 need to be clear of all discrete post angles 740 in order for the lock to disengage.

Turning to FIG. 8, the angled load plate lock configuration 700 is shown in an assembled and locked state, in accordance with some embodiments. In some embodiments, the pin recess 605 of all configurations described here is configured to have a travel angle 801 of 30° to 60°, which is the travel angle of the pins 507, 707, relative to a vertical line through the post 711, as the pins 507, 707 are moved to an unlocked state. This range offers the optimum combination of separation force from a withdrawal of post 711 from post receiver 708, and vertical magnetic force supplied by a magnetic key on polygon pins 707, such as the from key described in relation to

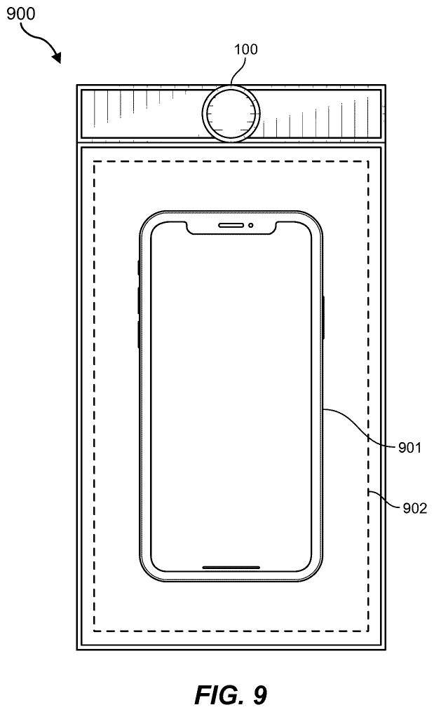

FIG. 9 depicts a non-limiting example embodiment of a container 90. FIG. 9 provides an example embodiment and use case for which lock 100 (or 700) can be positioned on container 900 to secure a device, as discussed supra.

As discussed above, container 900 (e.g., a secure pouch, for example) can house an electronic device (e.g., smart phone, for example) 901 in accordance with some embodiments. In some embodiments, container 900 may be in the form of a case, which can include a set of panels or materials secured together (e.g., front and back) or a single piece of material moulded into a shell. For example, container 900 can have an opening on one end, where housing extension component 501 is positioned proximate such opening on one side, and on the other side of the opening, base extension components 502 can be positioned. Thus, when such components are engaged and/or disengaged via the input (e.g., rotation of top 503, discussed supra), the opening of the container 900 can be opened and/or closed, respectively.

Container 900 is configured to secure personal electronic devices and other effects within an interior portion using the lock 100, which includes configuration 700 in some embodiments. In some embodiments, the container 900 can include an electromagnetic shield 902 configure to block electromagnetic radiation. The container 900 may be sized to receive a plurality of electronics devices (e.g., mobile device, laptop, tablet, and the like) and personal effects, among other items.

In some embodiments, container 900 may be embodied in various configurations and shapes. For example, the container may include a rigid shell or box, in some embodiments. In some embodiments, the container can include a case or material (e.g., flexible or malleable to at least a threshold value, for example) which includes the lock 100. In some embodiments, the container 900 may include various flexible materials such as neoprene, silicone rubber, spandex, vinyl, canvas, and/or any other type of known or to be known material or combinations of materials sufficient to temporarily house at least one electronic device. In some embodiments, the lock 100 may be positioned at the opening of the container 900, which may be in connection with an overlapping flap (not shown) or a “clam” type of opening, and the like, as one of ordinary skill in the art would understand.

According to some embodiments, certain aspects of the instant disclosure can be embodied via functionality discussed herein, as disclosed supra. According to some embodiments, some non-limiting aspects can include, but are not limited to the below apparatus aspects, which can additionally be embodied as system, method and/or device functionality:

Aspect 1. A lock comprising:
a top extension component having an associated protruding top feature, the top feature comprising a lock cavity, the lock cavity comprising a set of components that include a spring, load plate, set of pins and post receiver; and
a base extension component configured to securely adhere to and release from the top extension component via the set of components, wherein the top extension component and base extension component are shaped in a manner fit together to form a housing of the lock.
   Aspect 2. The lock of aspect 1, wherein the spring is configured to engage a top portion of the lock cavity on one end and the load plate on another end.
   Aspect 3. The lock of aspect 1, wherein the post receiver includes a set of pin recesses, wherein the load plate is configured to cover the set of pins when the set of pins are within the set of pin recesses.
   Aspect 4. The lock of aspect 1, wherein the top feature is configured as part of the top extension component.
   Aspect 5. The lock of aspect 1, wherein the top feature is configured as a separate component to the top extension component that securely affixes to a top surface of the top extension component.
   Aspect 6. The lock of aspect 1, wherein the top feature is configured to receive input that causes disengagement of the set of components to unlock the base extension component from the top extension component.
   Aspect 7. The lock of claim 6, wherein the input is at least one of a rotational input, force input, magnetic force input and torque input.
   Aspect 8. The lock of aspect 1, wherein the top feature is a cylinder shape.
   Aspect 9. The lock of aspect 1, wherein the load plate is configured to compress the spring, wherein the compression cause the lock to change to a locked state.
   Aspect 10. The lock of aspect 1, wherein the post receiver include a pin guide, wherein the load plate includes a plate aperture configured to enable the pin guide to pass therethrough.
   Aspect 11. The lock of aspect 10, wherein the pin guide includes one or more angled surfaces configured to guide the one or more pins upward and outward from a center of the post receiver. Aspect 12. The lock of aspect 10, the set of components within the lock cavity further comprising a post.
   Aspect 13. The lock of aspect 12, wherein the pin guide is configured to house a head portion of the post.
   Aspect 14. The lock of aspect 12, wherein the post is coupled to a fastener, wherein the fastener is coupled to the base extension component.
   Aspect 15. The lock of aspect 14, wherein the post is removably coupled to the fastener.
   Aspect 16. The lock of aspect 1, wherein the lock is configured via the top feature to be unlocked via rotation of the top feature, wherein rotation in a first direction causes engagement of the set of components and rotation in a second, opposite direction causes disengagement of the set of components.
   Aspect 17. The lock of aspect 1, wherein the lock is positioned proximate to an opening of a container that is configured to securely house a device when the lock is engaged.

It should be understood that the disclosed systems are not limited in its application to the details of construction and the arrangement of components set forth in the previous description or illustrated in the drawings. The systems and methods disclosed herein fall within the scope of numerous embodiments. The previous discussion is presented to enable a person skilled in the art to make and use the system according to some embodiments. Any portion of the structures and/or principles included in some embodiments can be applied to any and/or all embodiments, and it should be understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings should be viewed as part of the instant disclosure and should be understood to be readily incorporable into any description of the metes and bounds of the system. Any functional language in the drawings is a reference to the system being configured to perform the recited function, and structures shown or described in the drawings are to be considered as the system comprising the structures recited therein.

Furthermore, acting as Applicant's own lexicographer, Applicant imparts the explicit meaning and/or disavow of claim scope to the following terms: “Substantially” and “approximately” when used in conjunction with a value encompass a difference of 5% or less of the same unit and/or scale of that being measured (e.g., degrees, volume, mass, distance).

It should be understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A lock comprising:
a top extension component having an associated protruding top feature, the top feature comprising a lock cavity, the lock cavity comprising a set of components that include a spring, load plate, set of pins and post receiver; and
a base extension component configured to securely adhere to and release from the top extension component via the set of components, wherein the top extension component and base extension component are shaped in a manner fit together to form a housing of the lock.

2. The lock of claim 1, wherein the spring is configured to engage a top portion of the lock cavity on one end and the load plate on another end.

3. The lock of claim 1, wherein the post receiver includes a set of pin recesses, wherein the load plate is configured to cover the set of pins when the set of pins are within the set of pin recesses.

4. The lock of claim 1, wherein the top feature is configured as part of the top extension component.

5. The lock of claim 1, wherein the top feature is configured as a separate component to the top extension component that securely affixes to a top surface of the top extension component.

6. The lock of claim 1, wherein the top feature is configured to receive input that causes disengagement of the set of components to unlock the base extension component from the top extension component.

7. The lock of claim 6, wherein the input is at least one of a rotational input, force input, magnetic force input and torque input.

8. The lock of claim 1, wherein the top feature is a cylinder shape.

9. The lock of claim 1, wherein the load plate is configured to compress the spring, wherein the compression cause the lock to change to a locked state.

10. The lock of claim 1, wherein the post receiver include a pin guide, wherein the load plate includes a plate aperture configured to enable the pin guide to pass therethrough.

11. The lock of claim 10, wherein the pin guide includes one or more angled surfaces configured to guide the one or more pins upward and outward from a center of the post receiver.

12. The lock of claim 10, the set of components within the lock cavity further comprising a post.

13. The lock of claim 12, wherein the pin guide is configured to house a head portion of the post.

14. The lock of claim 12, wherein the post is coupled to a fastener, wherein the fastener is coupled to the base extension component.

15. The lock of claim 14, wherein the post is removably coupled to the fastener.

16. The lock of claim 1, wherein the lock is configured via the top feature to be unlocked via rotation of the top feature, wherein rotation in a first direction causes engagement of the set of components and rotation in a second, opposite direction causes disengagement of the set of components.

17. The lock of claim 1, wherein the lock is positioned proximate to an opening of a container that is configured to securely house a device when the lock is engaged.
